(19) United States
(12) Patent Application Publication
(10) Pub. No.: US 2006/0254330 A1
(43) Pub. Date: Nov. 16, 2006

(54) Lock with latch sensor

(75) Inventors: Arthur Geringer, Oak Park, CA (US); Richard Geringer, Moorpark, CA (US); David Geringer, Camarillo, CA (US)

Correspondence Address: KOPPEL, PATRICK & HEYBL, 555 ST. CHARLES DRIVE, SUITE 107, THOUSAND OAKS, CA, 91360, US

(73) Assignee: SECURITY DOOR CONTROLS

(21) Appl. No.: 11/399,837

(22) Filed: Apr. 7, 2006

Related U.S. Application Data
(60) Provisional application No. 60/669,674, filed on Apr. 8, 2005.

(51) Int. Cl. E05B 17/00

(52) U.S. Cl. 70/431

(57) ABSTRACT

A lock having a sensor, the lock comprising a housing defining a chamber with a longitudinal axis. A latch mechanism is located within the chamber of the housing and is movable relative thereto in a direction transverse to the longitudinal axis between a retracted position wherein the latch mechanism is substantially within the housing, and an extended position wherein the latch mechanism extends at least partially outside of the housing. The latch mechanism at least partially comprises a ferrous material. A first switch mechanism fixed within the chamber, the latch mechanism ferrous material causing the first switch mechanism to activate in one transverse position of the latch mechanism and the first switch mechanism deactivated in another transverse position of the latch mechanism.

This application claims the benefit of U.S. Provisional Application No. 60/669,674 to Geringer et al., filed on Apr. 8, 2006.

### BACKGROUND OF THE INVENTION

1. Field of the Invention

This invention relates to locks with sensors, and particularly a lock incorporating sensing and/or switching equipment therein in order to provide signals to an external source relating to the condition of the lock.

2. Description of the Related Art

Locks are well known and are available in many different forms and configurations. For the most part, however, locks comprise some form of housing which accommodates a reciprocating latch or lever, the latch being movable between an unlocked withdrawn position and a locked extended position. In the withdrawn position, the latch would normally be contained within the housing, while in the extended position, the latch would engage an external and adjacent object to effect the locking operation. The latch would normally be movable between the withdrawn and extended position in response to the rotation of a key in the lock, or rotation of a handle, although such movements may also be in response to electrical, magnetic, pneumatic or other types of mechanical activation.

It is also known to provide external sensors with respect to such locks. Conventionally, a sensing switch or other device may be located externally of the lock, in order to sense or determine the position of the latch bolt. The mechanical movement of the latch bolt into the extended position has the effect of activating the sensor in one way to provide signals as to its condition, while the sensor would be activated in another manner to indicate the withdrawn or unlocked position of the latch bolt.

It may be important to determine the position of the latch, namely, whether in the extended or retracted position, so that devices or systems can be connected to the lock and react according to the position of the latch. For example, the lock may be connected to an alarm system, such that when the lock is moved from the locked to an unlocked position while the alarm is operational, a signal will be provided to trigger the alarm. The lock may also be connected to video and/or audio recording equipment, heating and cooling systems, lighting systems, computers and/or other recording instruments to collect information on personnel or objects entering or leaving a particular area, especially areas which contain information or products which may be of a classified or confidential nature.

### SUMMARY OF THE INVENTION

One embodiment of a lock with sensor according to the present invention comprises a housing defining a chamber with a longitudinal axis. A latch mechanism is located within the chamber of the housing and is movable relative thereto in a direction transverse to the longitudinal axis between a retracted position wherein the latch mechanism is substantially within the housing and an extended position wherein the latch mechanism extends at least partially outside of the housing. The latch mechanism at least partially comprises a ferrous material. A first switch mechanism fixed within the chamber, the latch mechanism ferrous material causing the first switch mechanism to activate in one transverse position of the latch mechanism and the first switch mechanism deactivated in another transverse position of the latch mechanism.

One embodiment of a method of detecting the position of a latch mechanism within a housing of a lock according to the present invention comprises providing a lock having a lock housing with a longitudinal axis. A latch mechanism is movable in a direction transverse to the longitudinal axis between a retracted position and an extended position. The latch mechanism at least partially comprising a ferrous material. Mounting a first switch mechanism at a fixed location within the lock housing, with the switch mechanism closing in the proximity of a ferrous material. The switch mechanism is closed when the latch mechanism is in one position, and the switch member is opened when the latch mechanism is in another position. Transmitting signals from the switch member, according to the position of the latch mechanism to an external component remote to the lock.

One embodiment of a door system according to the present invention comprising a door having a lock, said lock comprising a latch mechanism movable between a retracted position wherein the latch mechanism is substantially within the housing and an extended position wherein the latch mechanism extends at least partially outside of the housing. The latch mechanism at least partially comprises a ferrous material. A first switch mechanism is fixed within the lock, the latch mechanism ferrous material causing the first switch mechanism to generate an activate signal in one position of the latch mechanism, and causing the first switch mechanism to generate a deactivate signal in another transverse position of the latch mechanism. The system further comprising a remote device, the activate and deactivate signals controlling or updating the remote device.

These and other features and advantages of the invention will be apparent to those skilled in the art from the following detailed description, taken together with the accompanying drawings.

### BRIEF DESCRIPTION OF THE DRAWINGS

FIG. 1 shows an exploded view of one embodiment of a cylindrical lock according to the present invention;

FIG. 2 shows an exploded sectional view of one embodiment of a switch that can be used in locks according to the present invention;

FIG. 3 shows a perspective sectional view of the switch in FIG. 2;

FIG. 4 shows a sectional view of the switch in FIG. 2, when open;

FIG. 5 shows a sectional view of the switch in FIG. 2, when closed;

FIG. 6 shows a sectional view of the switch in FIG. 2, in the presence of a defeat magnet;

FIG. 7 is a sectional view of the lock in FIG. 1;

FIG. 8 is a sectional view of another cylindrical lock according to the present invention using one switch;

FIG. 9 is a perspective view of still another embodiment of a cylindrical lock according to the present invention;

FIG. 10 is a diagram of one embodiment of a door system according to the present invention.

### DETAILED DESCRIPTION OF THE INVENTION

The invention provides a lock incorporating a sensing mechanism for detecting the position of the lock's latch retractor or latch bolt to determine if the lock is in the locked or unlocked condition. Locks according to the present invention typically comprise a housing member with a movable latch retractor. The latch retractor is movable between an unlocked withdrawn position and a locked extended position to move a latch bolt between the unlocked and locked positions. The movement of the latch retractor (or latch bolt) causes activation or deactivation of a switch member. The switch member, upon detecting a change in the condition of the lock, provides a signal to an external system that typically performs a predetermined function according to the condition of the lock.

The activation of the switch may cause different results at the external component, depending upon the nature of the external component. For example, in one embodiment the signal can be provided to a monitoring system that shunts an alarm circuit in the case where authorized personal are moving through the opening such as by key from the outside or exiting by the inside lever. In other embodiments, when the latch bolt is in the withdrawn position, it may switch off the external component, which may be a surveillance camera; on the other hand, it may switch on the external component, which may be a light. Thus, the movement of the latch retractor or latch bolt will have the effect of activating or deactivating the switch, with either one of these conditions being used by the external component according to the type of function it performs. In other words, the component, depending on its nature, may be switched either on or off when the latch is in the withdrawn position. The lock with sensor would be used appropriately to activate or deactivate the component, as appropriate, when the latch bolt is withdrawn.

The invention has particular application with respect to cylindrical locks. The invention, however, is not restricted to such locks, and can be used with any lock mechanism which includes a fixed housing and a movable mechanism therein, such as a latch retractor or latch bolt.

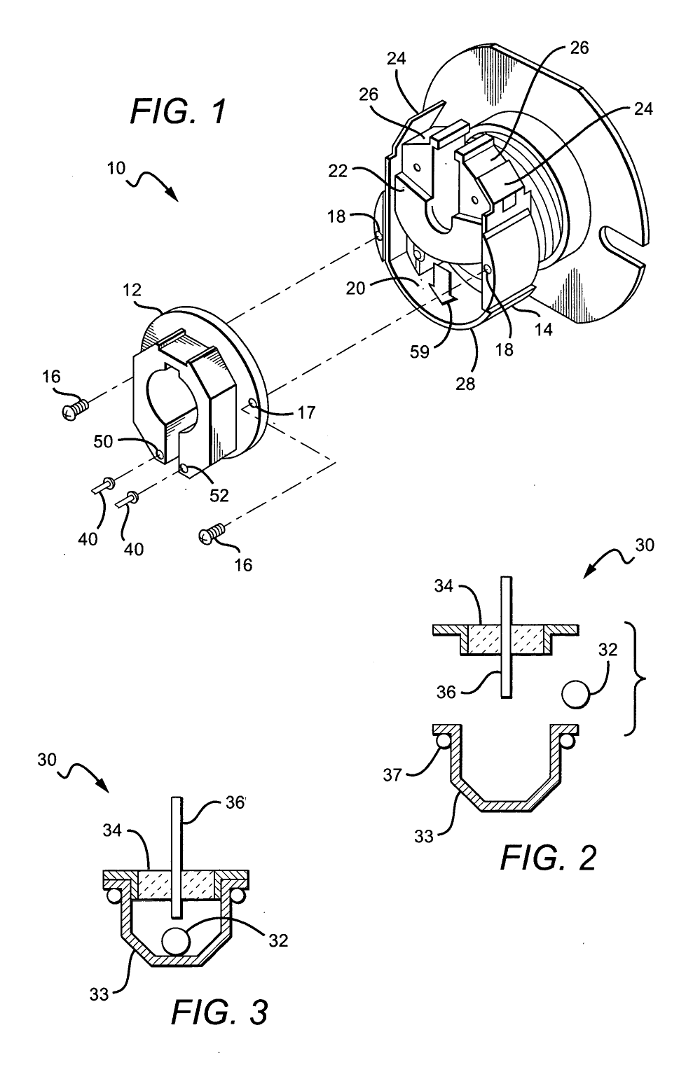

The drawings show the features of the invention in a more detailed embodiment of the invention. With reference to FIG. 1, there is shown a lock 10 that has many components that can be found in different conventional cylindrical locks, such as those commercially available from Schlage Incorporated. The lock 10 generally comprises a housing base 12 which is releasably attached to a housing 14, such as by screws 16, each of which pass through a respective one of said housing holes 17 and turn into threaded base holes 18. The screws 16 are tightened until the housing base is firmly attached to the housing 14.

The housing base 12 and housing 14, when connected, define a chamber 20 in which a latch retractor 22 and related components are contained. The latch retractor 22 as shown in FIG. 1 is shown in its extended position, with the latch mechanism typically being extended under the force of internal springs.

A first handle portion (shown as 56 is FIG. 7) typically extends from the housing base 12 and a second handle portion (shown as 58 in FIG. 7) extends in the opposite direction from the housing 14. In conventional fashion, the first and second handle portions can be rotated about their longitudinal axes, to move a latch retractor between an extended and retracted position against the force of the lock's internal springs. The rotational movement of the handles is thus converted to a linear motion of the latch retractor 22. The chamber 20 has abutment edges 24 which engage with angled abutment edges 26 of the latch retractor 22. The latch retractor 22 is, under normal conditions, biased the internal springs so that the latch retractor 22 is urged towards the extended position. Under this condition, the lock's abutment edges 26 engage the chamber's abutment edges 24. When the handle portions move the latch retractor 22 against the action of the springs, the latch retractor 22 is moved to its retracted position, and the extent of its travel is limited by a rear abutment plate 28.

The rotation of the outside lever may only be possible upon insertion of a key (not shown) within the lock, or by first using a key to allow rotation of the handle portions. It is understood that various permutations of the ability of these lever (handle) portions to rotate may be possible, and the invention is not limited to any one configuration.

The housing 14 is arranged to hold at least one magnetic switch/sensor (“magnetic switch”) 40 that is in fixed position to sense whether the latch mechanism 22 is retracted or extended. Many different magnetic switches can be used according to the present invention, with the preferred switch being activated by the relative movement of a metal portion in the latch mechanism, as opposed to a magnet. May different metals can be used, with a suitable metal being a ferrous metal. The term ferrous is used herein with its generally understood definition of a material relating to or containing iron. The movement of the ferrous metal in the lock mechanism, in relation to the switch causes the switch to move between the open and closed positions.

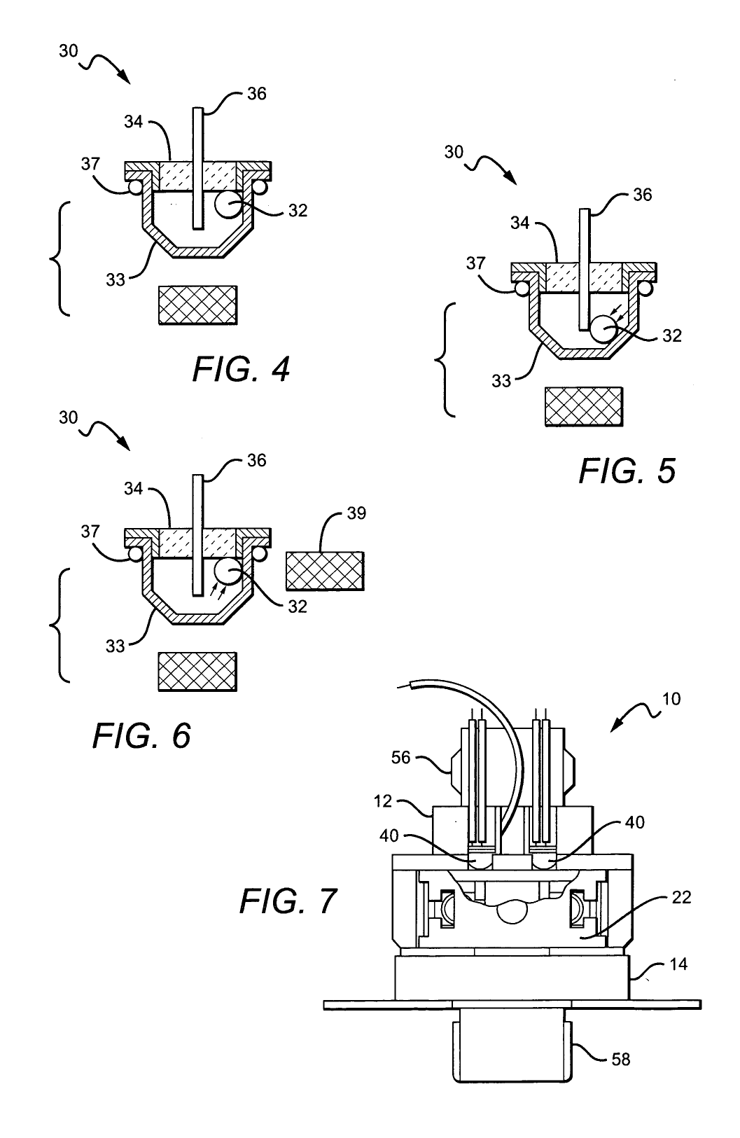

Many different switches can be used in the locks according to the present invention that can be activated in many different ways. One suitable switch that can be used is shown in FIGS. 2 through 6, and commercially available from Magnasphere Corporation under the Magnasphere® name. The switch 30 has an internal magnetic sphere (or ball contact) 32 that is housed in a durable non-ferrous metal housing 33. The housing is sealed with a cap 34 that contains the contacting electrode 36, insulated from the magnetic perimeter by a ceramic to metal bond. The electrode 36 provides the second contact point required to complete the electrical circuit of the switch. The seal/electrode cap is welded to the housing in an inert atmosphere providing an hermetically sealed contact. The housing 33 has an upper lip abutting the cap 34, with a ferro-magnetic ring 37 running around the upper lip.

The switch 30 utilizes the principle of spherical magnetism to provide security contacts that are resistant to magnetic tamper and defeat. The hermetically sealed metal construction makes the switch 30 durable and long lasting. The switch 30 also has a defined activation area and the switch is closed only when a magnet is present under the switch 30, pulling the magnetic sphere 32 to the bottom of the housing 33, contacting the electrode 36. Because the sphere 32 is a magnet, the switch 30 can be actuated by the presence of ferrous metal (i.e. an external magnet is not required) or alternatively it can be activated by the presence of a magnet. This feature allows the switch to be utilized as a ferrous proximity sensor.

In operation, when in the open position, the magnetic sphere 32 is attracted to the ferro-magnetic bias ring 37, away from the electrode 36. Because of this attraction, the switch 30 may be positioned in any orientation and will remain open. When an actuating ferrous metal (or magnet) approaches the switch from the end of the switch opposite the electrode, the magnetic sphere 32 is attracted to this field, and moves to the bottom of the housing 34, making contact with the electrode 36 and housing 34, closing the switch.

The switch 30 utilizes the principle of spherical magnetism. The spherical shape is not polarity sensitive and will be attracted to either pole of the actuating magnet. Unlike a reed switch that responds to a magnet within a global activation zone, the switch 30 responds to a magnet only within a restricted zone. As best shown in FIG. 6, a stronger magnet 39 outside the zone pulls the ball off the center electrode to open the switch.

Referring again to FIG. 1 along with FIG. 7, two switches 40 are shown mounted to the lock 10 to sense whether the latch is in the extended or retracted position. This can be done by mounting the sensors in many different locations in the lock 10, and in different embodiments either the rotational movement of the handle portions, or the linear movement of the latch or latch retractor can be sensed.

In the embodiment shown in FIG. 1, the switches are mounted to the housing base 12 to sense the linear movement of the latch retractor 22. Two switch holes 50, 52 are formed in the housing base 12 using known methods, when the housing base 12 is fabricated, or after fabrication, such as by drilling. Switch holes 50, 52 provide an opening in the housing base, to the latch retractor 22, and each of the switches 40 are mounted in a respective one of the switch holes 50, 52 and can be held in the holes using many different mechanisms, such as by press fit or by an adhesive.

In the embodiment shown, at least part of the latch retractor 22 is made of a ferrous material and linear movement of the latch tractor by rotation of either the first or second handle portions 56, 58, causes the latch retractor to move in the direction shown by arrows 59. This movement causes the latch retractor 22 to pass the switches 40. The switches 40 are usually open when the latch retractor 22 is in the position as shown in FIG. 1. When the latch retractor 22 moves linearly as shown by arrow 59, the latch retractor 22 is moved against the force of the springs (not shown) toward the rear abutment plate 28. As the ferrous material of the latch retractor passes the switch holes, the ferrous material moves the magnetic sphere in each of the switches to the bottom of its respective housing, thereby closing the switches.

The switch 10 has two switches 40, and in one embodiment according to the present invention, one of the switches 40 can be open in the presence of the latch retractor's ferrous material and the other can be closed. This allows the lock 10 to produce two different signals in the presence of the ferrous material. In an alternative embodiment, a single form switch could be used to sense the presence of the ferrous metal.

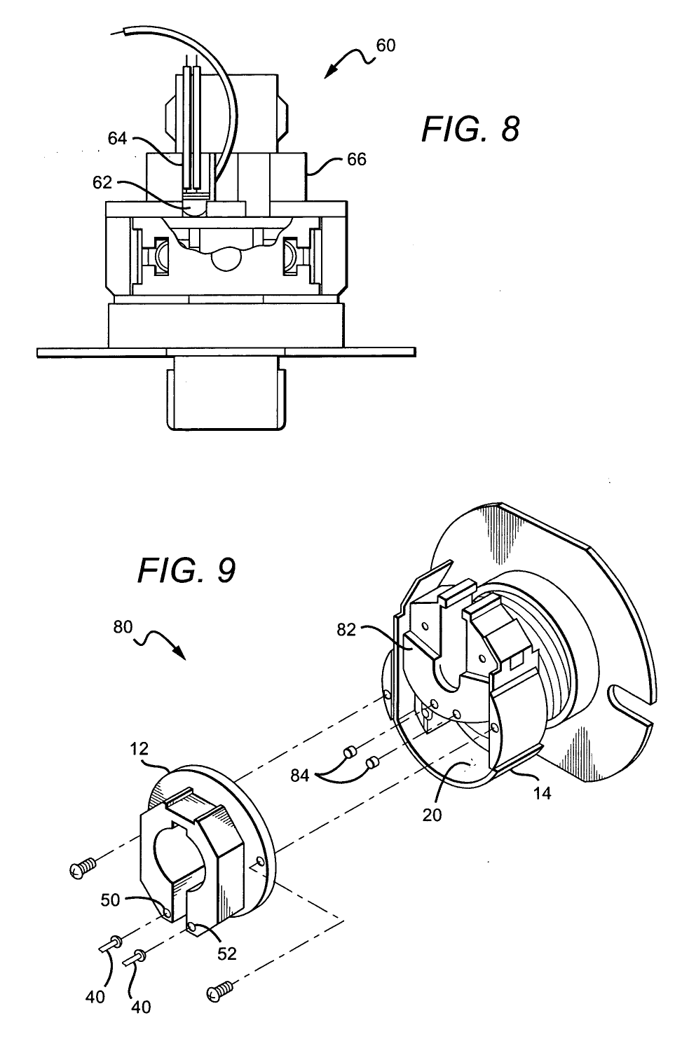

FIG. 8 shows another embodiment of a lock 60 according to the present invention having one switch 62 mounting in a switch hole 64 of the lock's housing base 66. In this embodiment, the magnetic sphere is again drawn to the base of the housing to open or close the switch 62 as the case may be. In a preferred embodiment, the switches magnetic sphere is drawn to the bottom of the housing where it makes contact with the electrode to close the switch.

FIG. 9 shows another embodiment of a lock 80 according to the present invention, wherein the switches are activated in the presence of one or more magnets, instead of a ferrous material. Particularly applicable to locks having non-ferrous retractors, such as locks having retractors made of other metals such as brass, copper, aluminum, or in locks having retractors made of other materials such as plastics.

Similar to the lock 10 in FIG. 1, lock 80 comprises housing base 12 and housing 14 that when connected form a chamber 20. Lock 80 also has a latch retractor 82 that is similar to the retractor 22 in FIG. 1, but latch retractor 82 has two magnets 84. The housing base 12 also has two switches 40 housed in switch holes 50, 52. The magnets 84 are positioned on the retractor 82 to operate on the switches when the latch retractor 82 is in the retracted position. When the retractor is shown in the extended position of FIG. 9, the magnets 84 do not operate on the switches 40. When the retractor 82 is retracted toward the rear abutment plate 28 the magnets 84 pass the switch holes 50, 52 and the magnets move the magnetic sphere in each of the switches to the bottom of its respective housing.

The switches 40 can be arranged such that one is open and the other is closed in the presence of the magnets 84, as described above. The lock 80 can also be arranged to house one or more than two switches, in different locations on the lock 80.

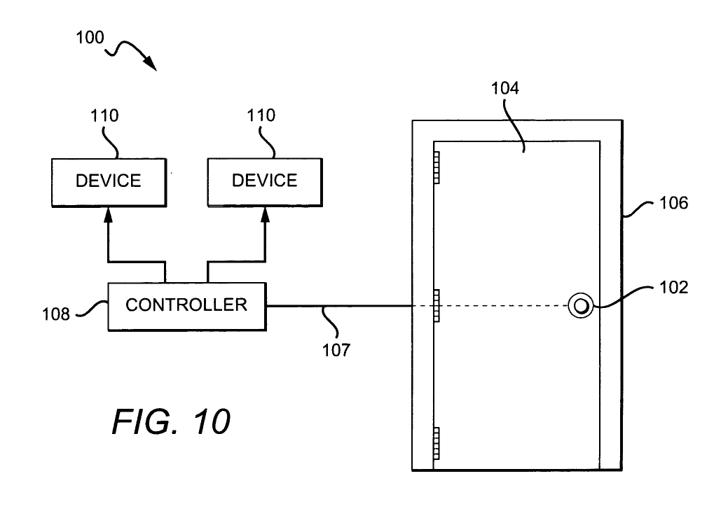

Each of the switches has an electrode extending from it carrying an electric signal reflecting whether the switch is open or closed. As an example see electrode 36 shown in FIGS. 2-6. Each of these electrodes is connectable to an external component, preferably by an electrical conductor such as a wire. FIG. 10 shows one embodiment of a door system 100 according to the present invention connected to the electrode in the switch mechanism, as described above, in the lock 102. The lock can be mounted in different devices in different ways, but is preferably mounted in a convention door 104 such that the lock's latch mechanism can engage a hole in the door frame 106. A wire 107 carrying the closed/open (switch activate and deactivate signals) state signals from the switch mechanism can be arranged in many different ways, but as shown run through the door 104 and door frame 106 to a controller 108. It is understood that the closed/open signals can be transmitted to the controller, or elsewhere, by many different transmission means, such as by wireless transmission.

It is understood that the controller 108 can accept signals from many locks or other devices. The controller takes the closed/open state signal and can generate signals to control or update one or multiple remote devices 110. Many different types of remote devices such an open/closed display, audio alarm, camera, lighting fixtures, computer, clock, etc. In other embodiments, the wire 107 can be connected directly to the remote device without the necessity of an intermediate controller.

Although the present invention has been described in considerable detail with references to certain preferred configurations thereof, other versions are possible. The invention can use different switches and can be used in different locks with different components. Therefore the spirit and scope of the invention should not be limited to the preferred version contained herein.

We claim:

1. A lock with sensor comprising:
a housing defining a chamber with a longitudinal axis;
a latch mechanism located within the chamber of the housing and being movable relative thereto in a direction transverse to the longitudinal axis between a retracted position wherein the latch mechanism is substantially within the housing and an extended position wherein the latch mechanism extends at least partially outside of the housing, said latch mechanism at least partially comprising a ferrous material; and
a first switch mechanism fixed within the chamber, said latch mechanism ferrous material causing said first switch mechanism to activate in one transverse position of said latch mechanism, said first switch mechanism deactivated another transverse position of said latch mechanism, respectively.

2. The lock according to claim 1, wherein the housing comprises a housing base and a housing cover defining the chamber, the housing having therein at least one internal bracket, said switch mechanism being mounted on said housing base.

3. The lock according to claim 2, further comprising a hole in said housing base, said switch mechanism mounted within said housing base hole.

4. The lock according to claim 1 further comprising a rotatable cylinder in the housing, the rotatable cylinder engaging, upon rotation, the latch mechanism to move the latch mechanism between the extended and retracted positions.

5. The lock according to claim 1, wherein said first switching mechanism comprises a movable magnetic contact, said movable contact activating said switch in said one transverse position of said latch mechanism, said movable contact deactivating said switch in said another transverse position of said latch mechanism.

6. The lock according to claim 1, wherein said movable magnetic contact closes said switch mechanism when said switch is activated and said movable magnetic contact opens said switch when said switch mechanism is deactivated.

7. The lock according to claim 1, further comprising a second switch mechanism fixed within the chamber, said latch mechanism ferrous material causing said second switch mechanism to activate in one transverse position of said latch mechanism, said second switch mechanism deactivated another transverse position of said latch mechanism, respectively.

8. The lock according to claim 7, wherein said second switch mechanism is deactivated when said first switch mechanism is activated.

9. The lock according to claim 7, wherein said second switch mechanism is activated when said first switch mechanism is activated.

10. The lock according to claim 1, wherein the first switch mechanism further comprises an electrode extending therefrom and being connectable to an external component.

11. The lock according to claim 1, wherein said electrode is connectable to an external component by a wire.

12. A lock according to claim 10, wherein the external component is a device selected from one or more of the group consisting of, display, audio alarm, camera, lighting fixtures, computer and clock.

13. A method of detecting the position of a latch mechanism within a housing of a lock, comprising:
providing a lock having a lock housing with a longitudinal axis and a latch mechanism being movable in a direction transverse to said longitudinal axis between a retracted position and an extended position, said latch mechanism at least partially comprising a ferrous material,
mounting a first switch mechanism at a fixed location within said lock housing, said switch mechanism closing in the proximity of a ferrous material;
closing said switch mechanism when said latch mechanism is in one position, and opening said switch member when said latch mechanism is in another position; and
transmitting signals from the switch member, according to the position of the latch mechanism, to an external source remote to the lock.

14. The method of claim 1, wherein said switch mechanism comprises a movable magnetic contact, said movable contact closing said switch in said one transverse position of said latch mechanism, said movable contact opening said switch in said another transverse position of said latch mechanism.

15. A door system, comprising:
a door having a lock, said lock comprising,
a latch mechanism movable between a retracted position wherein the latch mechanism is substantially within the housing and an extended position wherein the latch mechanism extends at least partially outside of the housing, said latch mechanism at least partially comprising a ferrous material; and
a first switch mechanism fixed within said lock, the latch mechanism ferrous material causing said first switch mechanism to generate an activate signal in one position of said latch mechanism, and causing said first switch mechanism to generate a deactivate signal in another transverse position of said latch mechanism;
a remote device, said activate and deactivate signals controlling said remote device.

16. The door system of claim 15, further comprising a controller, said activate and deactivate signals transmitted to said controller and said controller generating signals to control said remote device based on said activate and deactivate signals.

17. The door system of claim 15, wherein said activate and deactivate signals are transmitted directly to said remote device.

18. The door system of claim 15, wherein said remote device in one of the devices from the group comprising open/closed display, audio alarm, camera, lighting fixtures, computer and clock.

19. The lock according to claim 1, wherein said first switching mechanism comprises a movable magnetic contact, said movable contact causing said switch to generate said activate signal in said one transverse position of said latch mechanism, and said movable contact causing said switch to generate a deactivate signal in said another transverse position of said latch mechanism.

20. The lock according to claim 1, further comprising a second switch mechanism, said latch mechanism ferrous material causing said second switch mechanism to generate an activate signal in one position of said latch mechanism, and causing said second switch mechanism to generate a deactivate signal in another transverse position of said latch mechanism.

21. The lock according to claim 20, wherein said second switch mechanism generates a deactivate signal when said first switch mechanism generates a activate signal.

22. The lock according to claim 20, wherein said second switch mechanism generate a activate signal when said first switch mechanism generates a deactivate signal.
